(19) United States
(12) Patent Application Publication
(10) Pub. No.: US 2026/0367321 A1
(43) Pub. Date: Nov. 19, 2026

(54) OPERATING METHOD OF OPTICAL DEVICE

(71) Applicant: Mitsubishi Electric Corporation, Tokyo (JP)

(72) Inventor: Keita MOCHIZUKI, Tokyo (JP)

(73) Assignee: Mitsubishi Electric Corporation, Tokyo (JP)

(21) Appl. No.: 19/475,672

(22) PCT Filed: Jul. 7, 2023
(86) PCT No.: PCT/JP2023/025251

§ 371 Date: Oct. 15, 2025

(51) Int. Cl. G02B 6/124; G02B 6/125

(52) U.S. Cl. CPC G02B 6/124; G02B 6/125

(57) ABSTRACT

An operating method of an optical device including a first optical waveguide and a second optical waveguide arranged side by side on a substrate, and an optical coupling region in which light is coupled between the first optical waveguide and the second optical waveguide, in which, in the optical coupling region, a grating structure in which a first refractive index material and a second refractive index material are alternately arranged at a period Λ is provided in a direction of propagation of the light around the first optical waveguide and the second optical waveguide, the second refractive index material having a refractive index lower than a refractive index of the first refractive index material, wherein the operating method is a method of operating the optical device by propagating light of frequency f that the period Λ satisfies 11c₀/(20n_{eff}·f)≤Λ≤3c₀/(4n_{eff}·f).

### TECHNICAL FIELD

The present disclosure relates to the field of an optical device.

### BACKGROUND ART

In optical devices using various materials such as silicon (Si), indium phosphide (InP), gallium arsenide (GaAs), gallium nitride (GaN), lithium niobate (LiNbO₃), and compound semiconductors based on these materials, optical waveguides have been widely used as a basic component of devices. The optical waveguides have a refractive index higher than that of the surrounding region to thereby confine light to a localized region which is formed to have a linear shape to propagate the light to a desired region.

Further, various waveguide-type devices based on optical waveguides have also been widely used as one of the basic components of optical devices to achieve various functions. Examples of such waveguide-type devices include: directional couplers that optically couple the optical propagation modes of two independent optical waveguides by bringing the two waveguides close to each other at a distance equal to or less than the wavelength of the propagating light to thereby transfer any power of the propagating light; multi-mode interference waveguides (MMIs) that form a wide waveguide to convert the eigenmode of the light propagating inside into multiple modes and split the propagating light into any number of waves or combine it by optical interference between the modes; polarization multiplexers/demultiplexers that split input light into polarizations to output them to different positions, or perform the reverse function; and grating couplers that have a diffraction grating structure in the direction of light propagation and diffract light of a desired wavelength or polarization upward or downward from the optical waveguide to thereby propagate light through space.

However, in the waveguide-type optical devices such as general directional couplers or MMIs, in order to sufficiently transfer the optical power propagating in one optical waveguide to the other optical waveguide, or, in order to equally distribute the input optical power to a plurality of outputs, a long distance of about several tens of times the wavelength of the propagating light is required, leading to the problem of an increased device size. Further, optical devices such as MMIs, polarization multiplexers/demultiplexers, and grating couplers have a small range of operating wavelengths or polarizations. In order to accommodate various wavelengths or polarizations, it is necessary to adopt approaches such as arranging devices corresponding to light with various attributes in parallel, which also increases the device's overall size. For example, 3 dB couplers or 3 dB splitters splitting 50% of the optical power to the other side, which are often used in directional couplers, have a problem that the tolerance range for the device length at which a desired transfer rate can be achieved is very narrow, approximately 1 micrometer. The fact that the device length within the tolerance range is small compared to the overall device length indicates that the directional couplers are susceptible to manufacturing errors.

As a technology to solve the problems described above, a periodic structure with a period equal to or less than the propagating light, known as a sub-wavelength grating (SWG) structure, has been introduced into a Si-based optical device in a direction perpendicular to two optical waveguides, which has succeeded in achieving reduction in device size, polarization independence, and wavelength independence (Non-Patent Literatures 1 and 2).

### CITATION LIST

### Non-Patent Literature

NPL 1: C. Ye et al., “Ultra-Compact Broadband 2×23 dB Power Splitter Using a Subwavelength-Grating-Assisted Asymmetric Directional Coupler,” JLT, vol. 38, no. 8 (2020)
NPL 2: P. Cheben, “Subwavelength integrated photonics,” Nature, vol. 560, pp. 565-572 (2018)

### SUMMARY OF INVENTION

### Technical Problem

NPLs 1 and 2 each disclose a technology for achieving a small directional coupler, but the SWG structure requires a periodic structure with a size equal to or less than the wavelength. In general, the refractive index of semiconductor optical materials such as Si and InP constituting the waveguide exceeds 3, and thus, a size of ⅓ or less of the wavelength is substantially required. For example, in a case where the wavelength is 1.5 μm, a periodic structure of 0.5 μm or less is required. In a case where the filling rate of the optical waveguide core material is 50%, a fine structure of about 0.25 μm is required. Forming a structure of such a size with high precision is difficult in optical semiconductor processes, and requires a high-precision process such as electron beam (EB) lithography, which leads to high costs.

The present disclosure has been made to solve the above problems and an object of the present disclosure is to provide an optical device that requires less machining precision than in conventional approaches and can be easily manufactured.

### Solution to Problem

An optical device according to the present disclosure is an optical device including a first optical waveguide and a second optical waveguide arranged side by side on a substrate, and an optical coupling region in which an interval between the first optical waveguide and the second optical waveguide is narrower than that in another region such that light is coupled between the first optical waveguide and the second optical waveguide, in which, in the optical coupling region, a grating structure in which a first refractive index material and a second refractive index material are alternately arranged at a period Λ is provided in a direction of propagation of the light around the first optical waveguide and the second optical waveguide, the second refractive index material having a refractive index lower than a refractive index of the first refractive index material, and the period Λ satisfies the following: 11c₀/(20n_{eff}·f)≤Λ≤3c₀/(4n_{eff}·f) in which c₀ represents speed of light in a vacuum, f represents a frequency of the light, and n_{eff} represents an effective refractive index corresponding to a guided mode in the optical coupling region.

### Advantageous Effects of Invention

According to the present disclosure, it is possible to achieve an optical device that requires less machining precision than in conventional approaches and can be easily manufactured.

### BRIEF DESCRIPTION OF DRAWINGS

FIG. 1 is a schematic top view illustrating a configuration of an optical device according to a first embodiment.

FIG. 2 is a schematic enlarged perspective view illustrating a configuration of an optical coupling region of the optical device according to the first embodiment.

FIG. 3 is a diagram illustrating an operating point of the optical device according to the first embodiment in comparison with an operating point of an optical device according to a comparative example.

FIG. 4 is a schematic diagram illustrating an operation of the optical device according to the first embodiment in comparison with an operation of the optical device according to the comparative example.

FIG. 5 is a diagram illustrating branching characteristics of optical power of the optical device according to the comparative example.

FIG. 6 is a diagram illustrating branching characteristics of optical power of an optical device according to another comparative example.

FIG. 7 is a diagram illustrating branching characteristics of optical power of the optical device according to the first embodiment.

FIG. 8 is a diagram illustrating a calculation model of the FDTD method.

FIG. 9 is a diagram illustrating characteristics of the optical device according to the comparative example.

FIG. 10 is a diagram illustrating characteristics of an optical device according to a second embodiment in comparison with a comparative example.

FIG. 11 is a diagram illustrating an operation of the optical device according to the second embodiment in comparison with the comparative example.

FIG. 12 is a schematic top view illustrating a configuration of an optical device according to a third embodiment.

FIG. 13 is a schematic enlarged perspective view illustrating a configuration of an optical coupling region of the optical device according to the third embodiment.

### DESCRIPTION OF EMBODIMENTS

### First Embodiment

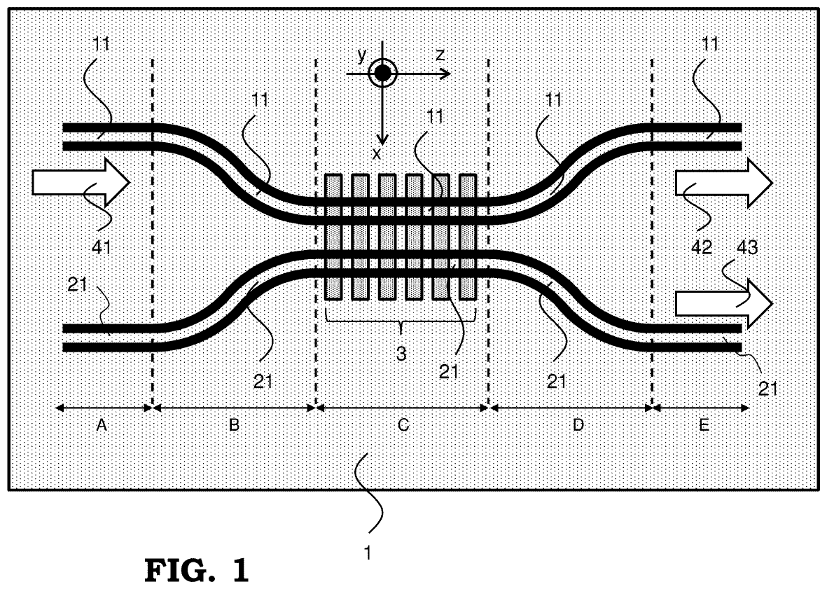

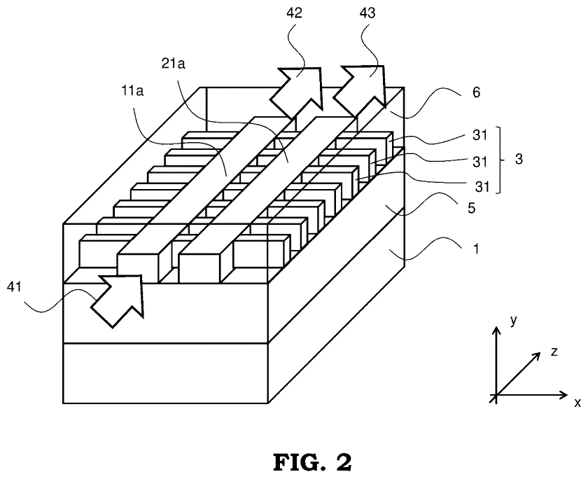

FIGS. 1 and 2 each illustrate a configuration of a directional coupler as an optical device according to the first embodiment. As illustrated in the plan view of FIG. 1, the directional coupler has, on a substrate 1, two optical waveguides, i.e., a first optical waveguide 11 and a second optical waveguide 21 that have therein a region with a refractive index higher than that of the surrounding region, and serve to confine light locally in the region to allow light to propagate only in a specific direction. As illustrated in FIG. 1, in a case where the directional coupler is divided into regions in the direction of light propagation in the order of an input region A, a width narrowing region B, a coupling region C, a width expanding region D, and an output region E, in each of the regions, the first optical waveguide 11 and the second optical waveguide 21 have the configuration as follows. In the input region A, the first optical waveguide 11 and the second optical waveguide 21 are disposed at a sufficient interval of several times or more the wavelength of light. In the width narrowing region B, the interval between the first optical waveguide 11 and the second optical waveguide 21 changes to narrow from the interval of several times or more the wavelength of the propagating light in the input region A to an interval approximately equal to the size of the wavelength. In the width narrowing region B, the length of the region is about 10 times or more the wavelength so that the first optical waveguide 11 and the second optical waveguide 21 are bent with no optical loss, and the first optical waveguide 11 and the second optical waveguide 21 are each bent by forming a curve such as a combination of arcs, a combination of sine waves or cosine waves, a cycloid curve, or a clothoid curve. In the optical coupling region C, the first optical waveguide 11 and the second optical waveguide 21 are disposed parallel and close to each other so that the interval therebetween is kept approximately constant at about the wavelength. Further, in the width expanding region D, the interval between the first optical waveguide 11 and the second optical waveguide 21 is increased to a sufficient interval of several times or more the wavelength of light from the size approximately equal to the wavelength, in contrast to the width narrowing region B. In the width expanding region D, the length of the region is about 10 times or more the wavelength, and the first optical waveguide 11 and the second optical waveguide 21 are each bent by forming a curve such as a combination of arcs, a combination of sine waves or cosine waves, or a cycloid curve. Further, in the output region E, the first optical waveguide 11 and the second optical waveguide 21 are disposed at a sufficient interval of several times or more the wavelength of light. This optical device serves as a directional coupler in which light of the first optical waveguide 11 and light of the second optical waveguide 21 are coupled in the optical coupling region C, which is the region where the interval between the first optical waveguide 11 and the second optical waveguide 21 is minimized.

FIG. 2 is an enlarged perspective view illustrating a part of the optical coupling region C. As illustrated in FIG. 2, the first optical waveguide 11 and the second optical waveguide 21 in the optical coupling region C include the substrate 1, a lower cladding layer 5 formed on the substrate 1, and core layers 11a and 21a that are provided on the lower cladding layer 5, serve to confine light, and are made of a material with a refractive index higher than that of the lower cladding layer 5. Further, the first optical waveguide 11 and the second optical waveguide 21 in the optical coupling region C include a grating structure 3, made of the same material as the core layer, in which protrusions (gratings) 31 are periodically and repeatedly arranged so as to be approximately perpendicular to the direction of light propagation and to penetrate both the core layer 11a and the core layer 21a. Further, the core layers 11a and 21a and the protrusions 31 are surrounded by surrounding cladding 6 made of a material with a refractive index lower than that of the material of the core layer, such as SiO₂ and SiN. That is, the grating structure 3 has a configuration in which the protrusions 31 made of a first refractive index material, which is the same material as the core layer, and the surrounding cladding 6 made of a second refractive index material with a refractive index lower than the first refractive index material are repeatedly arranged at a constant period, and the entire waveguide has a waveguide structure with a grating. The period Λ of the grating of the grating structure 3 is so set as to generally satisfy the following formula (1).

$$\begin{matrix}[ Formula 1 ] & \\ \frac{11 {c}_{0}}{20 {n}_{eff} \cdot f} \leq Λ \leq \frac{3 {c}_{0}}{4 {n}_{eff} \cdot f} & ( 1 )\end{matrix}$$

Here, c₀ represents the speed of light propagating in a vacuum, f represents the frequency of light propagating through the optical device, and n_{eff} represents the effective refractive index of a guided mode. The effective refractive index herein is a parameter determined depending on the structure and material of the optical waveguide, and is defined as a value equivalent to the refractive index when the optical waveguide is assumed to be made of a material with a constant refractive index, based on the propagation speed of the guided mode, even when the optical waveguide has a complex structure. In the drawings, light 41 input to the directional coupler and output light 42 and 43 branched by the directional coupler are schematically illustrated with arrows. Further, the x, y, and z axes are shown in the drawings so that the correspondence between the directions in FIGS. 1 and 2 can be understood.

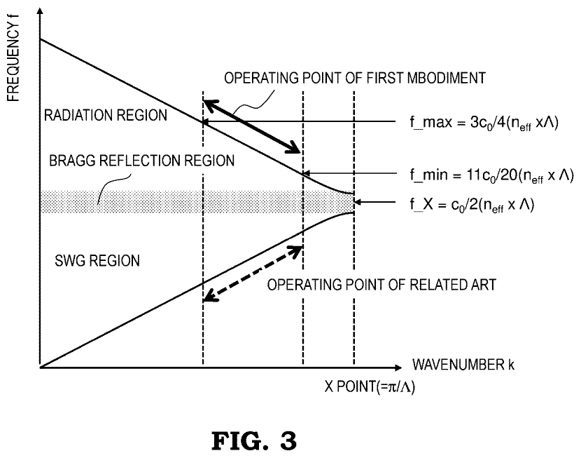

FIG. 3 schematically illustrates the dispersion relationship of light propagating through an optical waveguide with a grating. The horizontal axis represents the wavenumber and the vertical axis represents the frequency. Due to the action of the reciprocal lattice vector by the grating, the dispersion characteristic is turned back at a so-called X point (=π/Λ), and the dispersion characteristic is curved near the X point, resulting in a Bragg reflection region where no propagation mode is present. The lower frequency side than the Bragg reflection region is the SWG region. The optical waveguide with a grating shown in a related art has, as an operating point, the SWG region indicated by the dashed arrow in the drawing. On the other hand, the higher frequency side than the Bragg reflection region is a radiation region where the propagating light is radiated outside the waveguide and the power is attenuated. The operating point of the optical device according to the first embodiment is a region indicated by the solid arrow in FIG. 3. The period Λ of the grating is so set that an operating frequency f falls within a range of f_min to f_max illustrated in FIG. 3, that is, so set as to satisfy formula (1). The optical device according to the first embodiment has a characteristic of operating at a frequency that is equivalent to the wavenumber of the SWG device shown in the related art and is in the radiation region. By setting A in this way, it is possible to make the grating period Λ longer than that in the related art for the frequency f of light propagating through the same optical device, even though it is in the radiation region, leading to the effect of relaxing the fineness of the pattern that is used to form the grating.

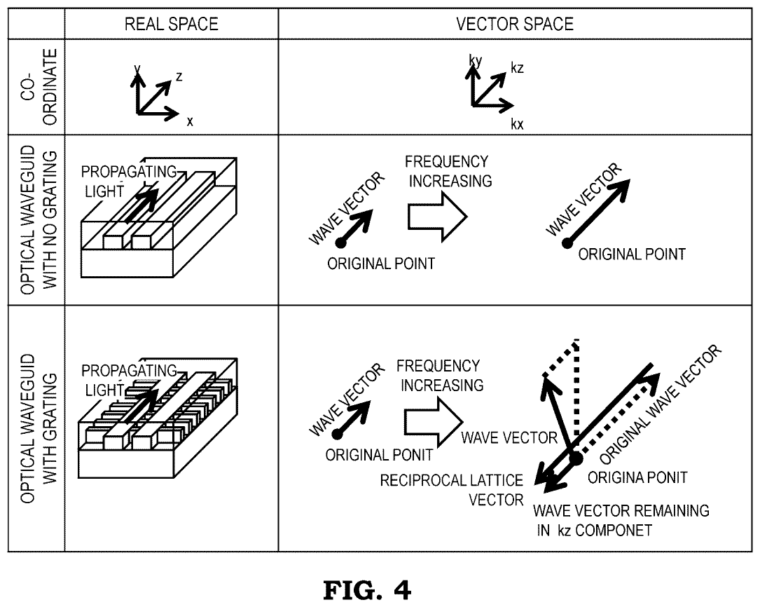

The effect of the structure described above will be described below. FIG. 4 schematically illustrates the relationship between light propagating in a directional coupler based on a normal optical waveguide and light propagating in a directional coupler based on an optical waveguide with a grating. In a structure based on the normal optical waveguide, the wave vector increases as the frequency of the propagating light increases. In contrast, in a structure based on the optical waveguide with a grating, the reciprocal lattice vector acts. In the case of operation in a frequency range higher than the Bragg reflection range, as in the technology of the present disclosure, the reciprocal lattice vector acts to turn back the wave vector of the propagating light, and as a result, a kz component of the wave vector can be set to a length similar to that of a conventional SWG. As a result, in the present disclosure, even with a long-period grating structure, an effect similar to that of a conventional SWG structure can be obtained.

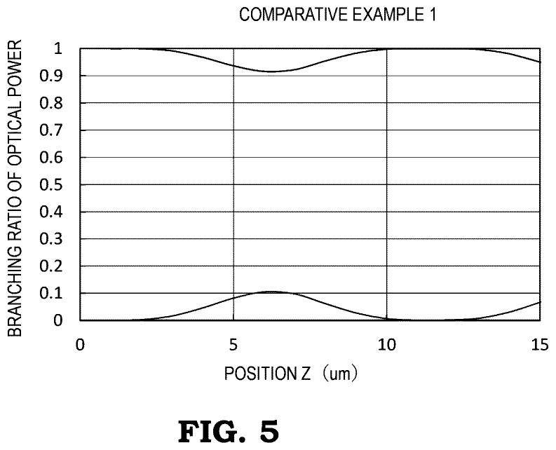

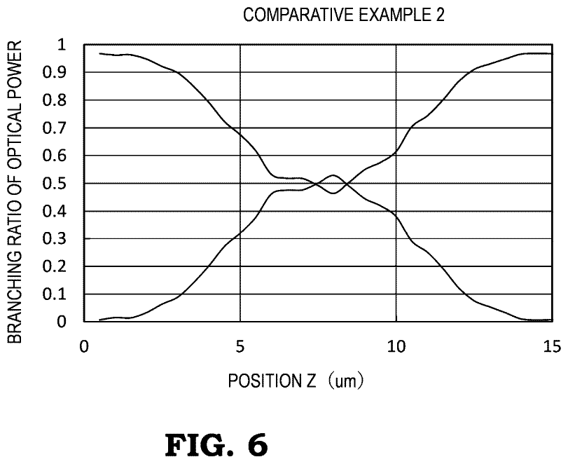

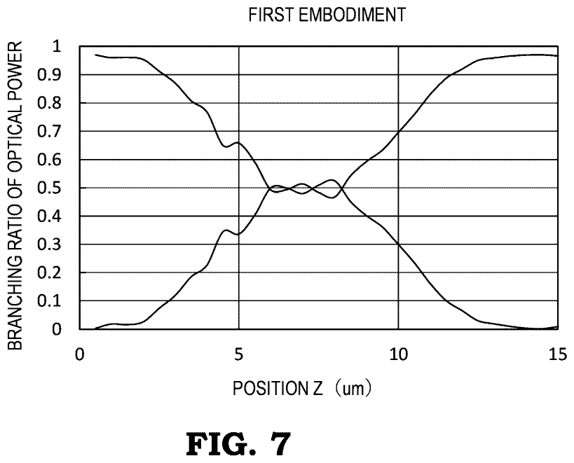

FIGS. 5 to 7 illustrate the results of calculations of the relationship between the length of the optical coupling region and the branching ratio of the optical power for a case where light with a wavelength of 1.55 μm is incident on a normal directional coupler with no grating structure, a directional coupler with a grating of an SWG structure, and a directional coupler with the grating structure according to the first embodiment, respectively. In each directional coupler, the first optical waveguide 11 and the second optical waveguide 21 in the optical coupling region are Si waveguides with a refractive index of 3.4, with widths of 0.4 μm and 0.5 μm, an interval of 0.2 μm, and a height of 0.25 μm, and are surrounded by SiO₂ cladding with a refractive index of 1.6 (n_{eff}=2.38). FIG. 5 illustrates the calculation results of a normal directional coupler with no grating structure as a comparative example. FIG. 6 illustrates the calculation results of a directional coupler having an SWG structure with a period of 0.22 μm (Λ=0.338c₀/(n_{eff}·f)) and a filling rate of 50% as a comparative example. FIG. 7 illustrates an example of the calculation results of the directional coupler according to the first embodiment, in which a grating structure with a period of 0.39 μm (Λ=0.600c₀/(n_{eff}·f)) and a filling rate of 50% is provided as the grating structure 3.

Incidentally, the reason why different widths are set for the first optical waveguide 11 and the second optical waveguide 21 is that the distance required for optical branching can be shortened by making the widths different. This effect becomes noticeable when the width ratio is about 1.2 times. The optimal ratio varies depending on the branching ratio to be designed. However, in a case where the width ratio becomes too large, such as twice or more, the difference in effective refractive index between the guided modes of the first optical waveguide and the second optical waveguide becomes too large, and a coupling mode is not formed.

As can be seen from FIG. 5, the normal directional coupler with no grating cannot achieve 50% power branching no matter how the length is set, but by adding the SWG structure as illustrated in FIG. 6, approximately 50% power branching can be achieved at a length of approximately 6 μm to 8 μm. Also, in the configuration according to the first embodiment of FIG. 7, even with a grating having a period approximately 1.8 times longer than the SWG, it is possible to achieve approximately 50% power branching at a length of approximately 6 μm to 8 μm, and it can be seen that characteristics equivalent to those of the conventional SWG structure are obtained. The fact that the directional coupler length at which the same power branching is achieved is long means that the manufacturing precision required for the directional coupler can be relaxed. At the same time, it also means that the optical length at which desired characteristics are obtained is long, which produces the effect of expanding the operating wavelength band.

The shape, material, and positional relationship of the directional coupler do not need to be limited to those of the first embodiment. For example, the positions of the optical waveguide on the input side and the optical waveguide on the output side may be interchanged, the material of the substrate 1 may be other materials such as Si, GaAs, SiO₂, SiN, LiNbO₃, and the core layer does not need to be Si, but may be any material having a higher refractive index than that of the cladding layer, for example, SiO₂ doped with Ge or the like for SiO₂ cladding. In such a case, the refractive index of the device is generally small, which is disadvantageous in that the device size becomes large, but the optical loss of the propagating light is small, which is advantageous in that a low-loss device can be achieved.

### Second Embodiment

The second embodiment is a modification to the first embodiment. The second embodiment has a characteristic that, in the directional coupler illustrated in FIGS. 1 and 2, the period of a grating 3 generally satisfies the following formula (2).

$$\begin{matrix}[ Formula 2 ] & \\ \frac{11 {c}_{0}}{20 {n}_{eff} \cdot f} \leq Λ \leq \frac{3 {c}_{0}}{5 {n}_{eff} \cdot f} & ( 2 )\end{matrix}$$

Here, c₀ represents the speed of light propagating in a vacuum, f represents the frequency of light propagating through the optical device, n_{eff} represents the effective refractive index of a guided mode, and Λ is the period of the grating 3.

In the first embodiment, it was confirmed that, even with a long-period grating, characteristics equivalent to those of a conventional SWG device can be obtained in terms of the branching ratio characteristics of optical power. However, this operating region is the radiation region in the dispersion relationship of the optical waveguide, which causes a problem that radiation loss is fundamentally unavoidable. In particular, in a case where the period Λ of the grating is large, in other words, in a case where the operating frequency is located above the dispersion characteristics in FIG. 3, the influence may be significant. However, in a case where Λ is in a range that satisfies formula (2), it is possible to achieve the effects described in the first embodiment while reducing the attenuation of propagating light due to the radiation mode, which is a disadvantage when introducing a long-period grating.

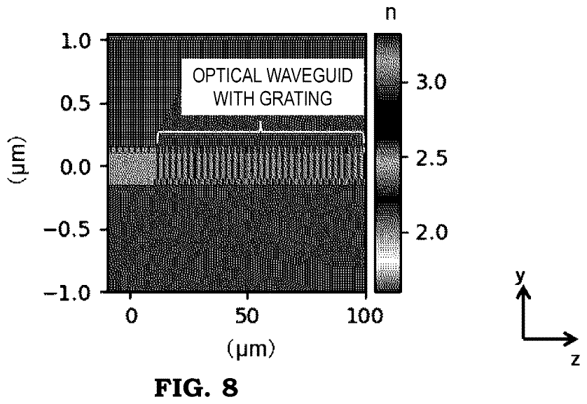

The effects of this embodiment will be described below. The radiation loss in each structure was calculated using electromagnetic field simulation (Finite Difference Time Domain Method: FDTD method). FIG. 8 illustrates a calculation model for the FDTD method. An optical waveguide with a grating of 0.22 μm in height is provided in the cladding from 10 μm to 100 μm, and a normal optical waveguide of the same height is used from 0 μm to 10 μm. The refractive index n is 3.4 for the protrusion 31 of the grating structure, 1.6 for the surrounding cladding 6, and 3.4 for the optical waveguide. In this model, the basic mode of the optical waveguide is excited at the position X=0 μm and propagated toward the right in the drawing. The relationship between the propagation distance and the power of the propagating light for a case where the grating period is changed in various ways was calculated.

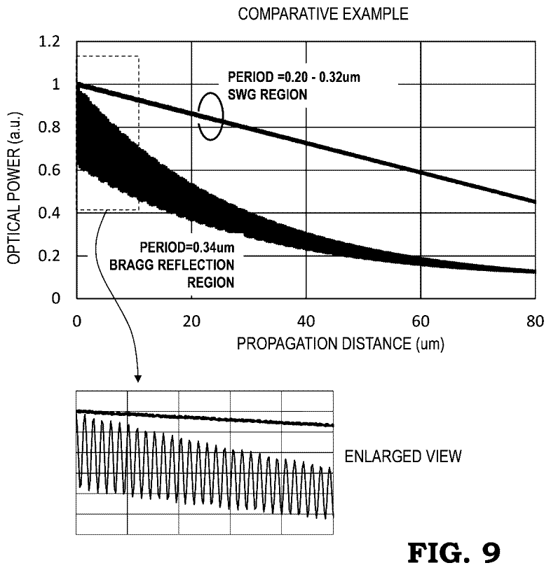

FIG. 9 illustrates the calculation results of the radiation loss in the SWG region and in the Bragg reflection region in FIG. 3. It can be seen that in the SWG region where the period Λ is 0.20 μm to 0.32 μm (Λ is 0.307 c₀/(n_{eff}·f) to 0.491 c₀/(n_{eff}·f)), there is no excess loss depending on the grating period. It can be seen that in the Bragg reflection region where the period Λ is 0.34 μm (Λ=0.522 c₀/(n_{eff}·f)), there is no propagation mode in the optical waveguide with a grating, so the power attenuates while oscillating greatly according to the propagation distance.

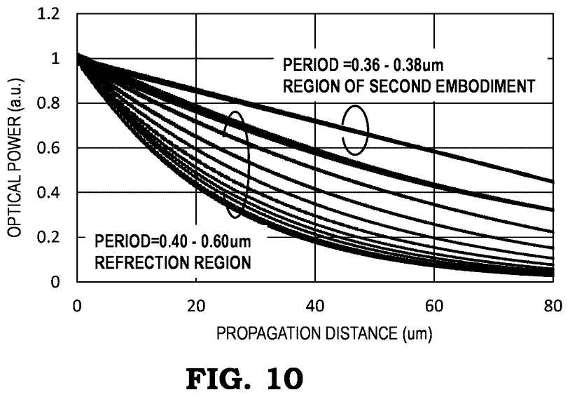

FIG. 10 illustrates the calculation results of the radiation loss in the radiation region in FIG. 3. In the structure of the second embodiment in which the period Λ is 0.36 μm to 0.38 μm (Λ is 0.553 c₀/(n_{eff}·f) to 0.583 c₀/(n_{eff}·f)), although there is a small loss because it is a radiation region, it can be seen that the loss is reduced to approximately the same level as the loss characteristic of the SWG region in FIG. 9. On the other hand, in the region where the period Λ is increased to 0.40 μm to 0.60 μm (Λ is 0.614 c₀/(n_{eff}·f) to 0.922 c₀/(n_{eff}·f)), it can be seen that the radiation loss is large and the optical power of the propagating light is greatly attenuated.

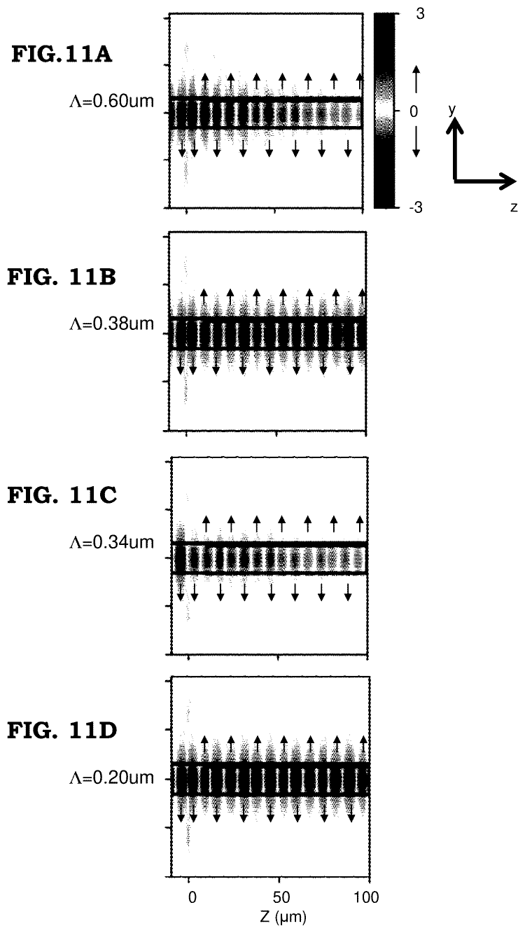

FIG. 11 illustrates the calculation results of the electromagnetic field distribution of the propagating light for a case where the period Λ is 0.20 μm (Λ=0.307 c₀/(n_{eff}·f)) (FIG. 11D), 0.34 μm (Λ=0.522 c₀/(n_{eff}·f)) (FIG. 11C), 0.38 μm (Λ=0.583 c₀/(n_{eff}·f)) (FIG. 11B), and 0.60 μm (Λ=0.922 c₀/(n_{eff}·f)) (FIG. 11A). In FIG. 11, an upward arrow (⬆) indicates a positive electric field and a downward arrow (⬇) indicates a negative electric field, and the darker the line, the larger the absolute value. In the structures with large radiation loss illustrated in FIGS. 9 and 10, it can be seen that the intensity of the propagating light decreases toward the right.

### Third Embodiment

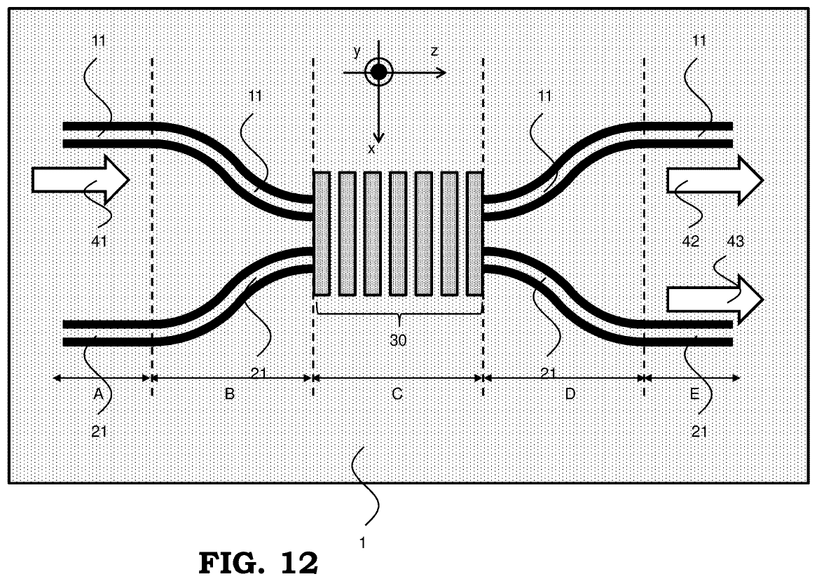

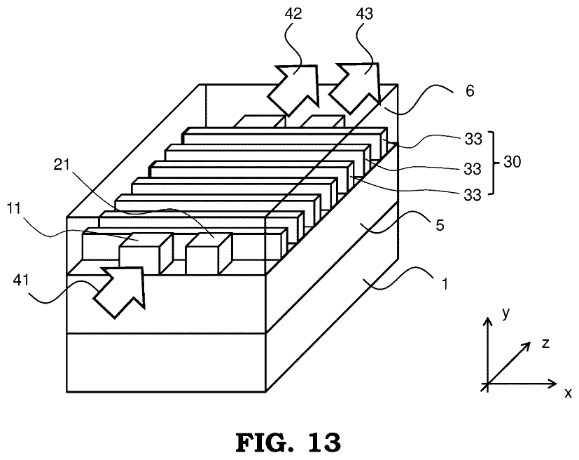

FIGS. 12 and 13 each illustrate the configuration of an optical device according to the third embodiment. In the optical device, an optical coupling region is a multi-mode interference waveguide (MMI). As illustrated in the plan view of FIG. 12, the optical device has, on the substrate 1, two optical waveguides, i.e., the first optical waveguide 11 and the second optical waveguide 21 that have therein a region with a refractive index higher than that of the surrounding region, and serve to confine light locally in the region to allow light to propagate only in a specific direction. As illustrated in FIG. 12, in a case where the optical device is divided into regions in the direction of light propagation in the order of the input region A, the width narrowing region B, the coupling region C, the width expanding region D, and the output region E, in each of the regions, the first optical waveguide 11 and the second optical waveguide 21 have the configuration as follows. In the input region A, the first optical waveguide 11 and the second optical waveguide 21 are disposed at a sufficient interval of several times or more the wavelength of light. In the width narrowing region B, the interval between the first optical waveguide 11 and the second optical waveguide 21 changes to narrow from the interval of several times or more the wavelength of the propagating light in the input region to an interval approximately equal to the size of the wavelength. In the width narrowing region B, the length of the region is about 10 times or more the wavelength so that the first optical waveguide 11 and the second optical waveguide 21 are bent with no optical loss, and the first optical waveguide 11 and the second optical waveguide 21 are each bent by forming a curve such as a combination of arcs, a combination of sine waves or cosine waves, a cycloid curve, or a clothoid curve. In the optical coupling region C, a grating structure 30 is formed to configure an MMI portion, which allows light to enter the grating structure 30 from the first optical waveguide 11 and the second optical waveguide 21. Also, the configuration allows light from the grating structure 30 in the optical coupling region C to be coupled again to the first optical waveguide 11 and the second optical waveguide 21 in the width expanding region D. In the width expanding region D, the interval between the first optical waveguide 11 and the second optical waveguide 21 is increased from an amount approximately equal to the wavelength size, which is the distance on the optical coupling region C side, to a sufficient interval of several times or more the wavelength of light, in contrast to the width narrowing region B. In the width expanding region D, the length of the region is about 10 times or more the wavelength, and the first optical waveguide 11 and the second optical waveguide 21 are each bent by forming a curve such as a combination of arcs, a combination of sine waves or cosine waves, or a cycloid curve. Further, in the output region E, the first optical waveguide 11 and the second optical waveguide 21 are disposed at a sufficient interval of several times or more the wavelength of light.

As illustrated in FIG. 13, the MMI portion of the optical coupling region C includes the substrate 1, the lower cladding layer 5 formed on the substrate 1, the grating structure 30 made of, on the lower cladding layer 5, a material with a refractive index higher than that of the lower cladding layer 5 and having gratings 33 disposed periodically and repeatedly to be approximately perpendicular to the direction of light propagation, and the surrounding cladding 6 made of a material such as SiO₂ or SiN with a refractive index lower than that of the material constituting the core layer disposed so as to surround the gratings 33 to achieve a waveguide structure with a grating. The period of the gratings 33 is so set as to generally satisfy the following formula (3) (the same formula as formula (1) in the first embodiment). In order to function as an MMI with sufficiently small optical loss, the width of the grating structure 30 in the x direction, i.e., the direction perpendicular to the direction of light propagation and parallel to the substrate 1, needs to be three times or more the wavelength of light.

$$\begin{matrix}[ Formula 3 ] & \\ \frac{11 {c}_{0}}{20 {n}_{eff} \cdot f} \leq Λ \leq \frac{3 {c}_{0}}{4 {n}_{eff} \cdot f} & ( 3 )\end{matrix}$$

Here, c₀ represents the speed of light propagating in a vacuum, f represents the frequency of light propagating through the optical device, n_{eff} represents the effective refractive index of a guided mode, and Λ represents the period of the gratings 33. In the drawing, arrows are used to schematically indicate the light 41 input to the directional coupler of this embodiment, and the output light 42 and 43 branched by the directional coupler. Further, the x, y, and z axes are shown in the drawings in order to understand the correspondence between the directions in FIGS. 12 and 13.

By adopting the third embodiment, it is possible to implement a power branching operation over a wide wavelength range, similar to the SWG structure MMI disclosed in the related art, with a long-period grating that requires less manufacturing precision. This provides the advantage of reduced manufacturing costs.

Although various exemplary embodiments and examples are described in the present application, various features, aspects, and functions described in one or more embodiments are not inherent in a particular embodiment, and can be applicable alone or in their various combinations to each embodiment. Accordingly, countless variations that are not illustrated are envisaged within the scope of the art disclosed herein. For example, the case where at least one component is modified, added or omitted, and the case where at least one component is extracted and combined with a component in another embodiment are included.

### REFERENCE SIGNS LIST

1: Substrate
3, 30: Grating structure
11: First optical waveguide
21: Second optical waveguide
C: Optical coupling region
31, 33: Gratings

1-4. (canceled)

5. An operating method of an optical device which comprises
a first optical waveguide and a second optical waveguide arranged side by side on a substrate,
an optical coupling region in which an interval between the first optical waveguide and the second optical waveguide is narrower than that in another region such that light is coupled between the first optical waveguide and the second optical waveguide, and
a grating structure in the optical coupling region, in which a first refractive index material and a second refractive index material are alternately arranged at a period Λ in a direction of propagation of the light around the first optical waveguide and the second optical waveguide, in which the second refractive index material has a refractive index lower than a refractive index of the first refractive index material,
wherein the operating method is a method of operating the optical device by propagating light of frequency f through the optical device in which the period Λ satisfies 11c₀/(20n_{eff}·f)≤Λ≤3c₀/(4n_{eff}·f),
where c₀ represents speed of light in a vacuum, f represents a frequency of the light, and n_{eff} represents an effective refractive index corresponding to a guided mode in the optical coupling region.

6. The operating method of the optical device according to claim 5, wherein
the period Λ satisfies the following:
11c₀/(20n_{eff}·f)≤Λ≤3c₀/(5n_{eff}·f).

7. The operating method of the optical device according to claim 5, wherein a width of the first optical waveguide is at least 1.2 times and at most 2 times a width of the second optical waveguide in the optical device.

8. The operating method of the optical device according to claim 6, wherein a width of the first optical waveguide is at least 1.2 times and at most 2 times a width of the second optical waveguide in the optical device.

9. An operating method of an optical device which comprises
a first optical waveguide and a second optical waveguide arranged side by side on a substrate,
and a grating structure in which a first refractive index material and a second refractive index material are alternately arranged at a period Λ in a direction of propagation of light, in which the second refractive index material has a refractive index lower than a refractive index of the first refractive index material and the optical device is so configured that light enters the grating structure from the first optical waveguide and the second optical waveguide, a width of the grating structure in a direction perpendicular to the direction of propagation of light and parallel to the substrate is three times or more a wavelength of the light,
wherein the operating method is a method of operating the optical device by propagating light of frequency f through the optical device in which the period Λ satisfies 11c₀/(20n_{eff}·f)≤Λ≤3c₀/(4n_{eff}·f),
where c₀ represents speed of light in a vacuum, f represents a frequency of the light, and n_{eff} represents an effective refractive index corresponding to a guided mode in the grating structure.
